(19) United States
(12) Patent Application Publication
(10) Pub. No.: US 2006/0217005 A1
(43) Pub. Date: Sep. 28, 2006

(54) Electrical connector jack

(75) Inventor: Wolfgang Langhoff, Leonberg (DE)

Correspondence Address: BLANK ROME LLP, 600 NEW HAMPSHIRE AVENUE, N.W., WASHINGTON, DC, 20037, US

(73) Assignee: Amphenol-Tuchel Electronics GmbH, Heilbronn (DE)

(21) Appl. No.: 11/386,831

(22) Filed: Mar. 23, 2006

(30) Foreign Application Priority Data
Mar. 26, 2005 (DE) 10 2005 013 989.2

(51) Int. Cl. H01R 13/187

(52) U.S. Cl. 439/843

(57) ABSTRACT

The invention relates to a process for producing an electrical connector jack and to an electrical connector jack which is made as a radial contact jack and which has several longitudinal contact elements for making contact with a plug, and a sleeve which surrounds the longitudinal contact elements. To prevent contact resistance and for purposes of more economical production, the longitudinal contact elements and the sleeve are made integrally.

The invention relates to an electrical connector jack constructed as a radial contact jack and having several longitudinal contact elements for making contact with a plug and a sleeve which surrounds the longitudinal contact elements. Furthermore the invention relates to a process for producing an electrical connector jack with several longitudinal contact elements for making contact with a plug and with a sleeve which surrounds the longitudinal contact elements.

U.S. Published Patent Application 2002/0187686 A1 shows a sleeve with a T-shaped terminal capable of producing a laminated contact consisting of a lamellar cage and a rolled contact holder which are twisted into an “hourglass shape” in a complex manner with the aid of various devices.

U.S. Pat. No. 4,657,335 describes a jack which is formed by the relative rotary motion of the ends of a lamellar cage in a sleeve. Rings are put on the respective ends of the sleeve to fix the lamellar cage in the sleeve.

The object of this invention is to produce an electrical connector jack more easily and thus more economically, while at the same time avoiding contact resistance between various components as much as possible.

The basic idea of the invention is to construct the longitudinal contact elements and the sleeve integrally in one piece. This object is achieved by a process of the invention for producing an electrical connector jack with several longitudinal contact elements for making contact with a plug and with a sleeve which surrounds the longitudinal contact elements for making contact with a plug-side cable set. Preferably, the electrical conductor jack is made from an integral conductive workpiece, especially a metal sheet.

The electrical connector jack of the invention is preferably produced by the following process steps:
punching out a base shape and punching out the longitudinal contact elements which extend over a first component area of the base shape,
folding the base shape at the transition of the first component area into the second component area,
rolling up the folded base shape into an essentially cylindrical jack, the first component area with the longitudinal contact elements forming the inside of the jack and the second component area forming the sleeve of the jack,
producing a first non-positive connection either on the contact seam of the first component area of the rolled-up base shape or on the contact seam of the second component area of the rolled-up base shape,
displacement of the first component area relative to the second component area in the direction of rotation,
producing a second non-positive connection on the still open contact seam of either of the second component area or the first component area.

The displacement of the first component area relative to the second component area in the direction of rotation can also take place before producing a first nonpositive connection either on the contact seam of the first component area of the rolled-up base shape or on the contact seam of the second component area of the rolled-up base shape. The displacement can take place by gripper arms or spreading means which are frictionally locked to the first and/or second component area and are rotated oppositely.

The integral design of this invention largely avoids gaps and the contact resistance at contact points resulting from these gaps. Together with the longitudinal contact elements, which provide for high current flow with a minimum voltage drop, the connector jacks of the invention have higher a current carrying capacity with a minimum temperature rise.

Furthermore, a contact surface as large as possible with a matched plug and a longer service life are possible due to reduced contact pressure and accordingly less wear. Even a plurality of plug cycles surprisingly leads to less wear compared to conventional designs, due to a configuration in which the jack has several longitudinal contact elements which have been twisted into a hyperbolic shape.

Reliability during vibrations and impacts is likewise increased by the jack of the invention; this is advantageous especially in the automotive field due to the strong vibrations and other ambient influences present therein. It is especially preferred that there be a corresponding jack in a punched and folded structure.

If the longitudinal contact elements are formed by punching out intermediate spaces, this yields an especially form fit between the longitudinal contact elements.

In another embodiment configuration of the invention, it is provided that the longitudinal contact elements extend parallel to one another essentially over the entire length of the jack and that on each end of the longitudinal contact elements there are crosspieces integrated with the longitudinal contact elements, which run orthogonally and connect the longitudinal contact elements.

In another embodiment of the invention it is provided that there is a cable set terminal for making contact with the cable set integrally with the sleeve and the longitudinal contact elements.

This cable set terminal can also have a crimp geometry and moreover can ensure a special stability of the connector jack by strengthening the material in the area of the cable set terminal. For this reason there may be material of various gradations for implementing different material thicknesses.

As an alternative to the crimp geometry, the connector jack of the invention may also have a cable set terminal consisting of several pins/extensions for fixing the jack on a board. These pins are pushed through the board and are soldered on the back of the board.

The process step of displacing the first component area relative to the second component area in the direction of rotation may also take place by fixing the pins mounted on the first or second component area in the component with which contact is to be made, displacing the non-contact component area and then fixing the non-contact component on the component with which contact is to be made. In this way it is possible to install the jack in a pick-and-place process.

Other embodiments of the invention will become apparent from the claims, figures and the description below.

FIG. 1 shows a perspective view of a connector jack of the invention;

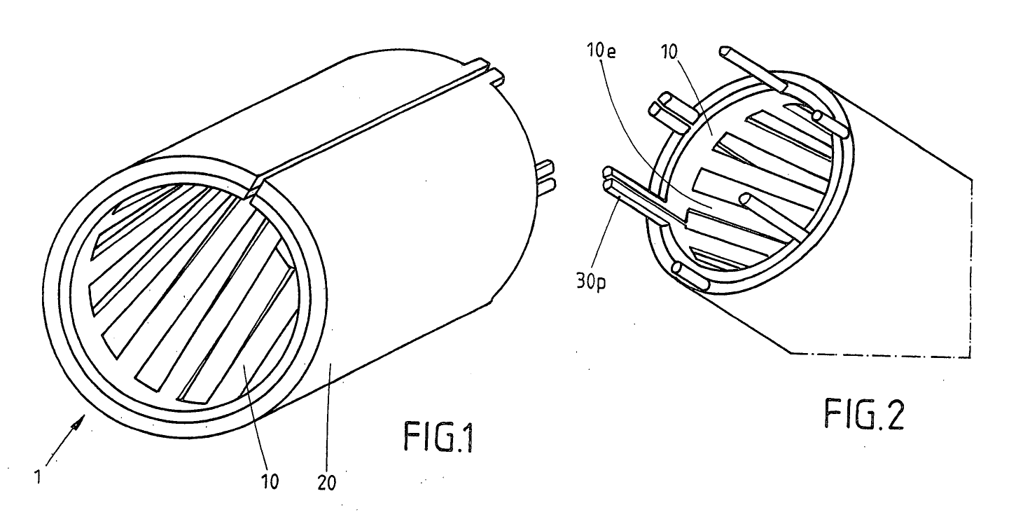

FIG. 2 shows a perspective partial view of the bottom of a connector jack of the invention with pins for soldering into a board;

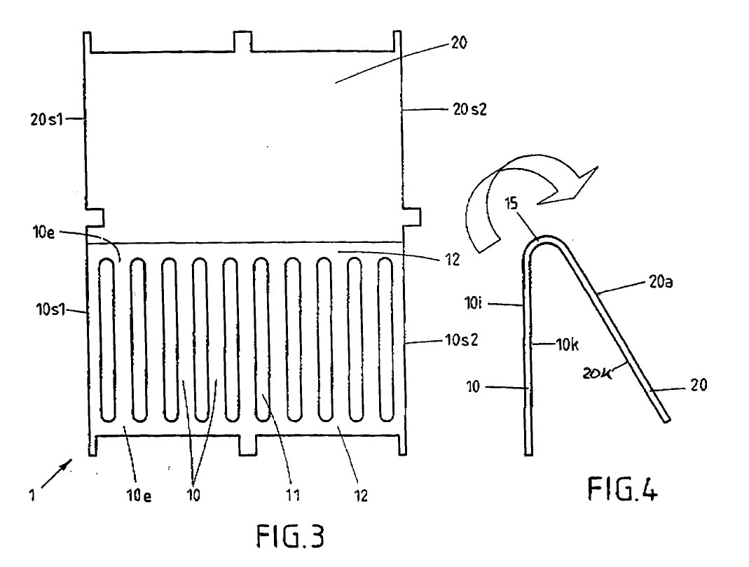

FIG. 3 shows a view of a connector jack after the process step of punching out;

FIG. 4 shows a side view of a connector jack of the invention in the process step of folding;

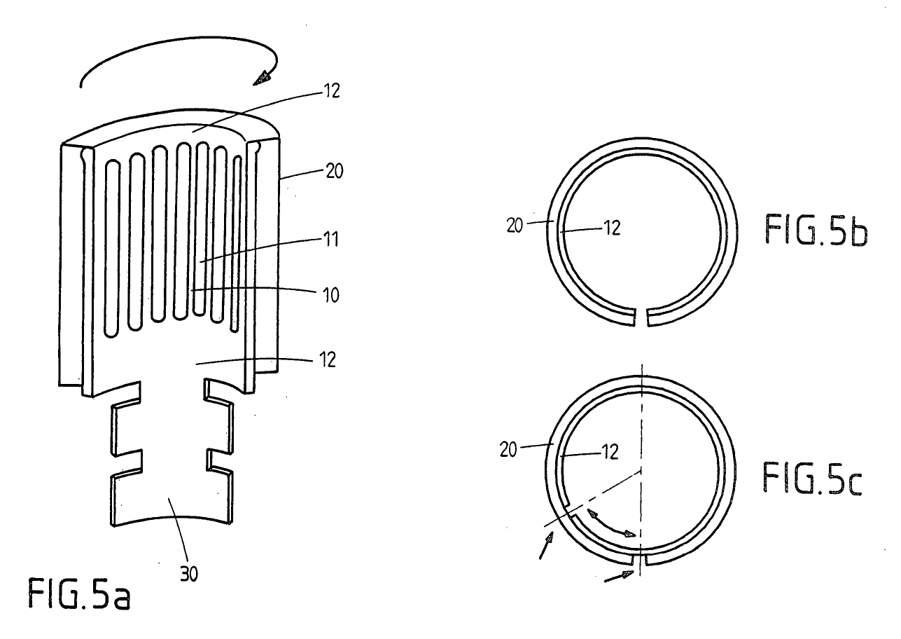

FIGS. 5a to 5c shows different views of a connector jack of the invention in the process step of rolling up.

The operation and structure of the electrical connector jack 1 as claimed in the invention as shown in FIG. 1 is best described by the production steps shown in FIGS. 3, 4 and 5.

The electrical connector jack 1 is formed from the base shape shown in FIG. 3. The base shape has essentially two component areas, specifically a first component area from which the longitudinal contact elements 10 with intermediate spaces 11 and frames 12 are formed, and a second component area from which the sleeve 20 is formed. The longitudinal contact elements 10 are distributed uniformly and parallelly over the rectangular first component area, and are formed by punching out the intermediate spaces 11. During this process the frames 12 are also formed. The frames 12 are connected to the longitudinal contact element ends 10e of the longitudinal contact elements 10 and are made integral with them. The metal from which the base form is punched out can consist of a material of varying graduation by which different material thicknesses can be provided in the different component areas.

In a second step, as shown in FIG. 4, the base form 1 is folded together in the transition area between the first and second component area until the first and the second component area are in flat contact with the contact surfaces 10k, 20k of the longitudinal contact elements 10 and of the sleeve 20.

In the next step, the folded base shape is rolled in the orthogonal direction to the lengthwise extension of the longitudinal contact elements 10 in the direction which is shown by the arrow in FIG. 5a, the longitudinal contact elements 10 forming the inner surface 10i of the connector jack 1 and the outer surface 20a of the sleeve 20 constituting the outer surface of the connector jack 1.

The connector jack 1 is rolled up until the lateral end faces 10s1, 10s2 of the first component area 10 and the lateral end faces 20s1, 20s2 of the second component area 20 meet on the contact seam.

Subsequently, either the end face 20s1 is fixed with the end face 20s2 or the end face 10s2 with the end face 10s2. In a preferred embodiment, the fixing takes place by a non-positive connection, for example welding or caulking. Alternatively, the fixing may take place by any other material connection and/or positive connection known to one skilled in the art (see FIG. 5b).

Subsequently the longitudinal contact elements are twisted in a relative-rotational manner against one another. However, in doing so the side with the fold 15 remains fixed and only the opposite side can be twisted. This yields a hyperbolic shape of the longitudinal contact elements which form the contact area, as is known to one skilled in the art.

After being twisted up to a certain angle, the two still open end faces 10s1 and 10s2 and 20s1 and 20s2 are non-positively connected on the contact seam. In a preferred embodiment, the angle of the relative-rotational twisting is 45° (see FIG. 5c).

Through this process, the electrical connector jack 1 of FIG. 1 is formed, into which a correspondingly shaped plug (not shown) can be plugged. Contact with the electrical line to be connected or with the electrical cable set can be made in various ways. FIG. 5a shows a crimp area which is molded integrally to the first component area of the base shape and is punched out at the same time as the intermediate spaces 11. This avoids further contact resistance.

Alternatively, the crimp area can also be molded on the second component area. FIG. 2 shows another embodiment with an alternative crimp area. Here legs or pins 31 are provided which can be plugged into a board in the corresponding through openings and soldered on the back. Form-fitting insertion into the holes in the board can also be done depending on the application and is also contemplated by the invention.

### REFERENCE NUMBER LIST

1 electrical connector jack
10 longitudinal contact elements
10e longitudinal contact element ends
10s1
10s2
   end faces
20s1
20s2
10k
   contact surfaces
10i inner surface (of the first component area)
11 intermediate spaces
12 frames
15 fold (between first and second component area)
20 sleeve
20a outer surface (of second component area)
30 cable set terminal
31 pin

1. An electrical connector jack (1), particularly made as a radial contact jack, comprising:
several longitudinal contact elements (10) for making contact with a plug, and
a sleeve (20) which surrounds the longitudinal contact elements (10),
wherein, the longitudinal contact elements (10) and the sleeve (20) are made integrally.

2. The electrical connector jack (1) as claimed in claim 1, wherein the jack (1) has several longitudinal contact elements (10) which have been twisted into a hyperbolic shape.

3. The electrical connector jack (1) as claimed in claim 1, wherein the longitudinal contact elements (10) and the sleeve (20) are provided in a punched and folded construction.

4. The electrical connector jack (1) as claimed in claim 1, wherein the longitudinal contact elements (10) are formed by punching out the intermediate spaces (11).

5. The electrical connector jack (1) as claimed in claim 1, wherein the longitudinal contact elements (10) extend parallel to one another essentially over the entire length of the jack (1) and on each end (10e) of the longitudinal contact elements (10) there are frames (12) which are integral with the longitudinal contact elements (10), which run orthogonally and which connect the longitudinal contact elements (10).

6. The electrical connector jack (1) as claimed in claim 1, wherein there is a cable set terminal (30) for making contact with the cable set integrally provided with the sleeve (20) and the longitudinal contact elements (10).

7. The electrical connector jack (1) as claimed in claim 6, wherein the cable set terminal (30) has a crimp geometry.

8. The electrical connector jack (1) as claimed in claim 6, wherein the cable set terminal (30) has strengthening of the material.

9. The electrical connector jack (1) as claimed in claim 6, wherein the cable set terminal (30) consists of several pins (30p) for fixing the jack (1) on a board.

10. A process for producing an electrical connector jack with several longitudinal contact elements for making contact with a plug and with a sleeve which surrounds the longitudinal contact elements from an integral conductive workpiece, especially a metal sheet.

11. The process as claimed in claim 10 comprising the steps of:
punching out a base shape and punching out the longitudinal contact elements which extend over a first component area of the base shape,
folding the base shape at the transition of the first component area into the second component area,
rolling up the folded base shape into an essentially cylindrical jack, the first component area with the longitudinal contact elements forming the inside of the jack and the second component area forming the sleeve of the jack,
producing a first connection either on the contact seam of the first component area of the rolled-up base shape or on the contact seam of the second component area of the rolled-up base shape,
displacement of the first component area relative to the second component area in the direction of rotation, and
producing a second connection on the still open contact seam either of the second component area or of the first component area.
